(19) United States
(12) Patent Application Publication
(10) Pub. No.: US 2005/0027778 A1
(43) Pub. Date: Feb. 3, 2005

(54) Automatic configuration of an address allocation mechanism in a computer network

(76) Inventors: Arthur Dimitrelis, Auburn (AU); Aidan Michael Williams, Chifley (AU)

Correspondence Address: DANIEL K. NICHOLS;Motorola, Inc. - Law Department, 1303 E. Algonquin Road, Schaumberg, IL, 60196, US

(21) Appl. No.: 10/629,061

(22) Filed: Jul. 29, 2003

(51) Int. Cl. G06F 15/16

(52) U.S. Cl. 709/200

(57) ABSTRACT

The invention provides a method, computer program and system for automatic and dynamic configuration of an address allocation mechanism in a computer network. The invention provides for allocating network addresses to the devices in the computer network by obtaining routing protocol messages (301), the routing protocol messages being exchanged in the computer network for routing purposes. Then the invention obtains network prefix addresses that correspond to sub-networks (501), the network prefix addresses being obtained using the routing protocol messages. Thereafter, the invention determines a range of valid network addresses for the devices using the network prefix addresses (503). These valid network addresses can then be allocated to hosts requiring network addresses. The current invention also continuously monitors the routing protocol messages to dynamically adapt the address allocation mechanism with changes in the addressing configuration of the computer network.

### FIELD OF THE INVENTION

The current invention relates to the field of address allocation mechanisms in computer based networks.

### BACKGROUND OF THE INVENTION

Over the last few decades, there has been an explosive growth in the use of computer networks and the Internet. Organizations are increasingly using computer networks to communicate and exchange information with employees and customers, and also to share resources within the organization.

A computer network usually comprises a number of various inter-connected sub-networks, which in turn comprise a plurality of hosts connected to each other. The term hosts, refers to computing devices such as servers, workstations, personal computers and the like. The computer network also comprises one or more routers that route and forward packets to their destination(s). A router is often characterized as a computing device that is connected to a plurality of sub-networks/networks, and forwards packets from one to another.

In order to facilitate the communication between various devices or hosts in the network, a unique network address, typically having a 32 bit length, is allocated to each host and each router. This unique network address enables a host to uniquely identify other hosts involved in the communication, and transfer data in an unambiguous manner.

Conventionally, network addresses have been allocated statically by a network administrator during the configuration of the computer network. In case of static allocation, the network administrator configures each host machine and each router manually with a unique address. Generally, this static approach is adequate for networks that have a limited number of hosts, and where the network addresses assigned to the hosts do not change frequently. However, the static allocation of network addresses is often inadequate for large or rapidly changing networks. This is because significant manual effort and time is needed for updating the hosts and routers with changing network configurations. Moreover, when considering address allocation for networks using IPv4, there is typically a limited number of addresses available, which implies that every host cannot be allocated a unique IPv4 address.

In order to overcome the shortcomings related to the static allocation of addresses to the hosts, a dynamic allocation of network addresses is carried out. In case of dynamic allocation, a network address is allocated to a host only when the host establishes an active connection with the computer network. When the host is not connected to the computer network, the network address corresponding to the host is withdrawn, and allocated to another host that requires a connection with the computer network.

Request for comments (RFC) number 2131 that is available at the website http://www.rfc-editor.org, describes one such dynamic address allocation mechanism, namely Dynamic Host Configuration protocol (DHCP). Without DHCP, the network address must be manually assigned to each host by a network administrator. With DHCP in place, a host can automatically obtain a network address from a DHCP server during the boot-up process. Thus, no intervention is required on the part of the user or the network administrator.

For the purpose of the allocation of IPv4 addresses, an address allocation mechanism, such as DHCP, needs to be configured so that it maintains range of valid IPv4 addresses that are compatible with the different sub-networks in the computer network. Valid IPv4 address of a host refers to an IPv4 address that has a network prefix address identical to that of the sub-network to which the host belongs. For example, in the case of DHCP, a DHCP server maintains a list of free IPv4 addresses. When a host requests an IPv4 address, the DHCP server cannot randomly allocate any address out of the group of free IPv4 addresses. This is because each of the sub-networks in the computer network has a different address prefix. Accordingly, the DHCP server must allocate only that free IPv4 address that has the same network prefix as that of the sub-network to which the requesting host belongs.

The existing address allocation mechanisms have one or more of the following limitations. Firstly, although address allocation mechanisms automate the process of allocation of IPv4 addresses to hosts, the configuration of the address allocation mechanisms with valid IPv4 addresses is performed manually. In present address allocation mechanisms like DHCP servers, network administrators determine a range of valid IPv4 addresses manually, and group them accordingly. This grouping is performed according to the compatibility of free IPv4 addresses with the different sub-networks with which the DHCP server is coupled. Once this grouping is in place, the DHCP servers allocate the IPv4 addresses to the requesting hosts.

Secondly, the existing address allocation mechanisms lack provisions for automatically adapting to changes in the network configurations. For example, network administrators may occasionally change network prefix addresses of the sub-networks, existing set of IP addresses may be modified/deleted, or a new set of IP addresses may be incorporated in the network. Currently, the network administrator makes these changes manually in order to adapt the address allocation mechanism to changing network configurations. In large or rapidly changing networks, this manual updating of address allocation mechanisms can consume a lot of time and effort.

Thus, in light of the abovementioned shortcomings, there is a need for a method and system that can automatically configure an address allocation mechanism with valid network addresses. Also, there is a need for a method and system that can automatically adapt the address allocation mechanism according to changing network configurations.

### SUMMARY OF THE INVENTION

The current invention provides a method and system for automatic configuration of an address allocation mechanism. The address allocation mechanism can either be centralized in the computer network, or it can be distributed across hosts in the computer network.

The method uses routing protocol messages in order to configure the address allocation mechanism with a range of valid network addresses. In case of DHCP address allocation mechanism, the routing protocol can be Open Shortest Path First (OSPF), and routing protocol message can be OSPF Link LSA. Routing protocol messages are exchanged between the routers in the computer network for routing purposes. Routing protocol messages include information about network prefix addresses corresponding to the sub-network to which the routing protocol message refers. The current invention extracts the network prefix addresses, and then uses it to determine range of valid network addresses for the hosts. These valid network addresses can then be allocated to the hosts requiring network addresses.

The current invention also continuously monitors the routing protocol messages to dynamically adapt the address allocation mechanism with changes in the addressing configuration of the computer network.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a block diagram of an environment in which a centralized address allocation mechanism operates, in accordance with an embodiment of the current invention;

FIG. 2 is a block diagram of an environment in which a distributed address allocation mechanism operates, in accordance with an embodiment of the current invention;

FIG. 3 is a flowchart of a method for automatic configuration of an address allocation mechanism in accordance with an embodiment of the current invention;

FIG. 4 shows the various fields in an OSPF Link LSA packet, in accordance with an embodiment of the current invention;

FIG. 5 is a flowchart of a method for configuration of centralized address allocation mechanism, in accordance with an embodiment of the current invention;

FIG. 6 is a flowchart of a method for configuration of a distributed address allocation mechanism;

FIG. 7 is a flowchart of a method for adapting an address allocation mechanism in response to changing network conditions; and

FIG. 8 is a block diagram of a system for automatic and dynamic configuration of a network address allocation mechanism, in accordance with an embodiment of the current invention.

### DETAILED DESCRIPTION OF PREFERRED EMBODIMENT OF THE INVENTION

The current invention provides a method and system for automatic and dynamic configuration of a network address allocation mechanism in a computer network. The current invention also dynamically updates the configuration of the address allocation mechanism to take account of any changes in network configurations. The computer network is a local area network (LAN) implementing, for example, Internet Protocol (IPv4) at the network layer. Although IPv4 is referred to in the remainder of this description by way of example, it is to be understood that the invention is not limited to computer networks using IPv4.

The computer network comprises various inter-connected sub-networks, which in turn comprise a plurality of hosts, or more generally devices,connected to each other. The hosts or devices in the computer network may be computing devices such as, but not limited to, workstations, servers, personal computers and network printers. The computer network also includes one or more routers that route and forward packets to their destination(s). The routers may use routing protocols such as, but not limited to, Open Shortest Path First (OSPF) and Routing Information Protocol (RIP), in order to route the packets, and determine appropriate routes. The routers may also connect the computer network to external networks, such as the Internet. This connection enables a host in the computer network to communicate with a device or host on an external network.

The address allocation mechanism as disclosed in the current invention can be either centralized or distributed in the computer network. In the centralized case, the address allocation mechanism dynamically allocates addresses to multiple hosts in the computer network. The multiple hosts may belong to either one sub-network, or different sub-networks. An example of such centralized address allocation mechanisms is a DHCP server.

In the distributed case, the address allocation mechanism is embedded on each host in the computer network. Thus, each host can choose a suitable IPv4 address without contacting a centralized server or router. One such distributed address allocation mechanism is described by S. Cheshire, B. Aboba and E. Guttman in the work in progress internet draft—draft-ietf-zeroconf-ipv4-linklocal-08, titled ‘Dynamic Configuration of IPv4 Link-Local Addresses’.

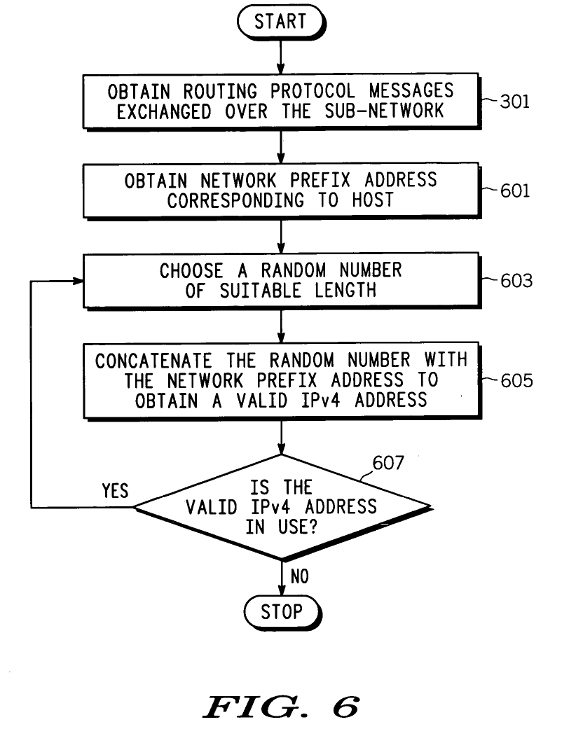

The scheme as given in this literature allows a host to configure itself with an address of the form 169.254.x.y. Such an address allows hosts on the same sub-network to communicate with each other. However, this address does not allow hosts on physically distinct sub-networks to communicate. The ‘169.254’ prefix is non-routable since a data packet sent by a host in a sub-network to an address with this prefix cannot be routed to a host outside the sub-network. An address with such a non-routable prefix is said to be ‘non-routable’. The current invention replaces the ‘169.254’ prefix with a routable prefix. In other words, the current invention makes it possible to use any network prefix address (rather than only one fixed network prefix 169.254). The host in a sub-network can then determine the applicable network prefix address (routable prefix) using the routing protocol address. An address with the prefix as the routable prefix is a routable address. Usage of these routable addresses allows hosts on distinct sub-networks to communicate with each other. The application of the current invention in the distributed case is explained in detail later in conjunction with FIG. 6.

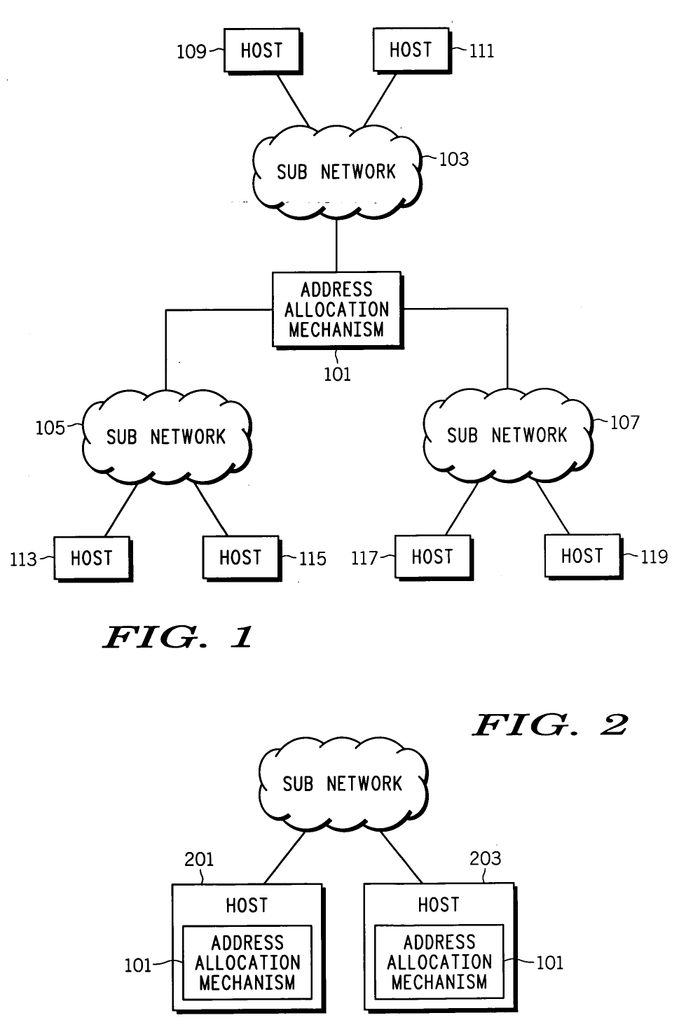

FIG. 1 is a block diagram of the environment in which a centralized address allocation mechanism operates. An address allocation mechanism 101 automatically allocates IPv4 addresses to hosts in the computer network. Address allocation mechanism 101 is connected to a plurality of sub-networks, namely a first sub-network 103, a second sub-network 105 and a third sub-network 107. Each sub-network consists of a plurality of hosts. For example first sub-network 103 consists of hosts 109 and 111. Similarly second sub-network 105 consists of hosts 113 and 115 and third sub-network 107 consists of hosts 117 and 119.

FIG. 2 is a block diagram of the environment in which a distributed address allocation mechanism operates. As shown, address allocation mechanism 101 is embedded on each of the hosts 201 and 203. Thus, hosts 201 and 203 can automatically select a suitable IP addresses without contacting any centralized entity or device.

FIG. 3 is a flowchart of a method for automatic configuration of an address allocation mechanism in accordance with one embodiment of the current invention. At step 301, the address allocation mechanism obtains routing protocol messages exchanged in the sub-network(s) to which the address allocation mechanism is connected.

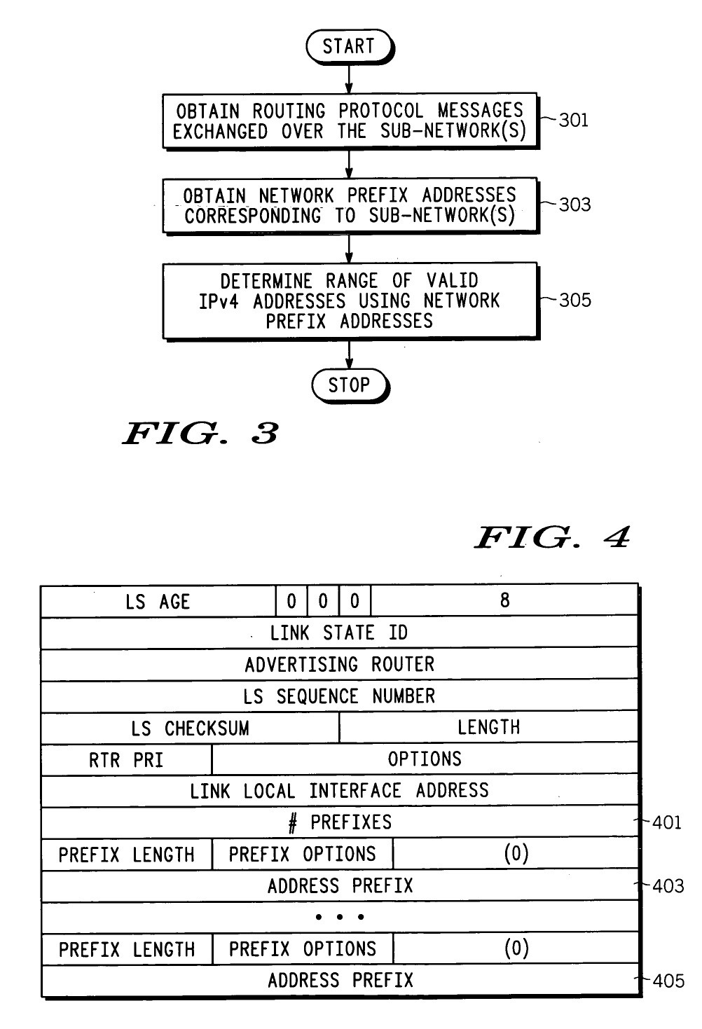

Routers in the computer network exchange routing protocol messages for routing purposes. Routing protocol messages are exchanged between the routers in the computer network for routing purposes. Routing protocol messages include information about network prefix addresses corresponding to the sub-network to which the routing protocol message refers. An example of the routing protocol message is OSPF Link-State Advertisement (LSA) packet, and is described later in conjunction with FIG. 4.

In the case of routing protocols such as OSPF (and others, including integrated IS-IS), routing protocol messages are broadcast to all devices on the sub-network. Hosts are capable of intercepting (or ‘snooping’) these routing protocol messages. To understand the content of routing protocol messages, hosts must run software that implements routing protocol functionality. This software is often incorporated into operating system. Address allocation mechanisms implementing this invention and using such software performs processing on the routing protocol message such as determining the network prefixes for sub-networks.

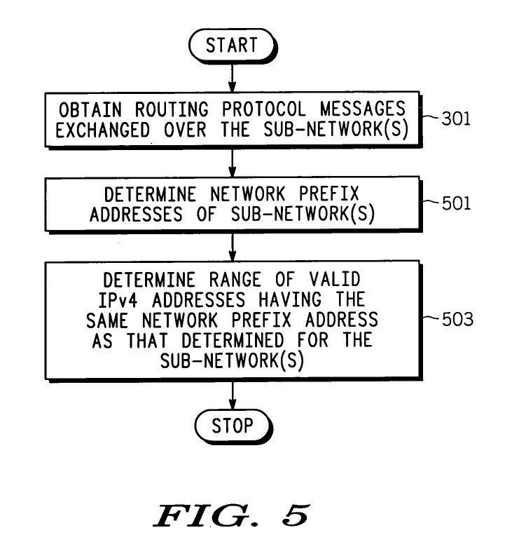

At step 303, the information about network prefix addresses corresponding to the sub-network(s) is extracted from the routing protocol messages, originating from the sub-network(s). At step 305, the network prefix addresses, determined at step 303, are used to determine range of valid IPv4 addresses applicable for the hosts in the sub-network(s). Valid IPv4 address of a host refers to an IPv4 address that has a network prefix address identical to that of the sub-network to which the host belongs. For example, if the network prefix address has been obtained as 165.124 for a sub-network, then a range of valid IPv4 address for all the hosts corresponding to the sub-network can be 165.124.x.y, where 0≦x≦255 and 0≦y≦255. The steps 303 and 305 are further elaborated later in conjunction with FIG. 5 and FIG. 6.

FIG. 4 shows the various fields in an OSPF Link LSA packet. This figure has been reproduced from RFC 2740 titled “OSPF for IPv6”. RFC 2740 is applicable for both IPv4 and IPv6 based computer networks. For the purpose of current invention, a first field 401, a second field 403, and a third field 405 are used. First field 401 gives the number of network prefix addresses applicable for the sub-network from which the routing protocol message is received. The applicable network prefix addresses are later listed one after the other in the Link LSA packet. Second field 403 and third field 405 list the two applicable network prefix addresses for the sub-network to which the Link LSA packet belongs. The listed network prefix addresses can then be used to determine the range of valid IPv4 addresses in both centralized and distributed address allocation mechanisms. More details about these fields and other fields of Link LSA packet can be found in RFC 2740.

The method of configuring an address allocation mechanism is now explained hereinafter with the help of various examples.

FIG. 5 is a flowchart of the method for configuring a centralized address allocation mechanism. The first step 301 is obtaining routing protocol messages exchanged over the network, as already described. At step 501, network prefix addresses corresponding to all the sub-networks, to which centralized address allocation mechanism 101 is connected, are determined. This is done by extracting information from routing protocol messages describing the sub-networks. At step 503, the IPv4 addresses in address allocation mechanism 101 are grouped into different sets for different sub-networks. This grouping is done on the basis of network prefix addresses determined for the sub-networks. For a sub-network linked to address allocation mechanism 101, IPv4 addresses having network prefixes identical to those determined for the sub-network, are grouped together.

### EXAMPLE 1

### DHCP Servers

A DHCP server, implementing the current invention, can be automatically configured to determine a range of valid IPv4 addresses corresponding to hosts for each of the sub-networks to which the DHCP server is connected. The current invention classifies the list of available IPv4 addresses into several groups corresponding to the different sub-networks (to which the DHCP server is connected). Each group corresponds to one sub-network, and contains a range of valid IPv4 addresses for the sub-network. The range of valid IPv4 addresses for a sub-network consists of the IPv4 addresses having the network prefix addresses same as those extracted from routing protocol messages for the sub-network, excluding prefixes that have been further subnetted. For example, if the prefix 10.54/16 is allocated to sub-network A and the prefix 10.54.199/24 is allocated to sub-network B, addresses of the form 10.54.199.x can only be allocated to sub-network B. Addresses of the form 10.54.x.y where x is not 199 can be allocated to sub-network A.

The working of DHCP servers implementing the current invention is now described in conjunction with FIG. 1. Address allocation mechanism 101 is a DHCP server. Consider that the network prefix address of first sub-network 103 is 164.231, of second sub-network 105 is 164.245, and of third sub-network 107 is 164.222. Now, through OSPF Link LSA packets coming from these sub-networks, DHCP server 101 is able to determine the network prefixes corresponding to each sub-network using routing protocol messages. Based on these network prefix addresses, DHCP server 101 would automatically group all available IP addresses having network prefix address 164.231 corresponding to first sub-network 103, all available IPv4 addresses with network prefix address 164.245 corresponding to second sub-network 105 and all available IPv4 addresses with network prefix address 164.222 corresponding to third sub-network 107. Now if a request for an IPv4 address is received from a host of second sub-network 105, then an IPv4 address available in the group corresponding to second sub-network 105 is assigned to the host. The IPv4 address allocated to the host would be of the form 164.245.x.y, where 0≦x≦255 and 0<y<255.

### EXAMPLE 2

### Routers

The method of the current invention can also be used to configure address allocation mechanisms for routers based on version 3 of the OSPF protocol. In other words, the address allocation mechanism can be embedded in the routing protocol, thus enabling the automatic and dynamic allocation of IPv4 addresses to router interfaces. The current invention enables the implementation of dynamic address allocation scheme in routers.

For dynamic IPv4 address allocation in routers, a master router is chosen from the routers in the computer network. The master router allocates IPv4 addresses to other routers (referred to as slave routers) in a manner similar to a DHCP server. For example, in OSPF based computer networks, a sub-network's designated router may also be the master router for the slave routers present in the sub-network. Whenever the master router detects a slave router requesting an IPv4 address (or detects a slave router whose previously allocated IPv4 address is no longer valid), it allocates a new valid IPv4 address to the slave router. The method, as described for centralized address allocation mechanisms in FIG. 5, is used to configure the master router with the valid IPv4 addresses corresponding to all the sub-networks (to which the slave routers are connected).

It may be noted that the address allocation mechanism for routers can either have a ‘pull architecture’ or a ‘push architecture’. The ‘pull architecture’ is similar in nature to DHCP, where the slave routers (equivalent to hosts) request the master router (equivalent to DHCP server) for allocation of IPv4 addresses. In ‘push architecture’, the master router itself finds out (by decoding routing protocol messages) which slave router requires an IPv4 address. In case the master router finds a slave router requiring allocation of an IPv4 address, it allocates a valid IPv4 address to the slave router.

Configuration in Distributed Address Allocation Mechanisms

FIG. 6 shows a flowchart of a method for configuration of a distributed address allocation mechanism. As described earlier, the address allocation mechanism is embedded on each host. The initial step 301 of obtaining routing protocol messages is performed similar to centralized systems. At step 601, network prefix address of the sub-network to which the host belongs is obtained from the routing protocol messages. The network prefix address is of predetermined length, and the length of the network prefix address (i.e. number of 0/1 bits contained in it) varies from sub-network to sub-network. For example, if the network prefix address is 164.86.15, then it can be represented by the following stream of bits in binary form:

“10100100−01010110−00001111”, where 10100100 corresponds to 164, 01010110 corresponds to 86, and 00001111 corresponds to 15.

Here the length of network prefix address is 8+8+8=24. The total length of an IPv4 address is 32 bits. This is because the format of an IPv4 address is A.B.C.D where A, B, C and D are 8 bit binary numbers.

Once the network prefix address is determined at step 603, a random number of a suitable length is generated in order to form a valid IPv4 address at step 603. The suitable length can be determined by using following formula:
Suitable length=Total length of IPv4 address−length of network prefix address.

In the above example, when the network prefix address is 164.86.15, the suitable length is 32-24=8. A random number could be 10000100, which corresponds to 132 in decimal notation.

At step 605, the generated random number is concatenated to the network prefix address obtained from routing protocol messages. This concatenated number forms the valid IPv4 address of the host. In the above example, the valid IPv4 address is 164.86.15.132.

At step 607, it is checked whether the valid IPv4 address, determined at step 605, has already been allocated to some other host in the computer sub-network. This can be achieved through Address Resolution Protocol (ARP) packets broadcasted to the hosts in the sub-network under consideration. In case some host in the sub-network is using the IPv4 address advertised in the ARP packet, the host using the IPv4 address would inform the broadcasting host about the same. In such a situation, steps 603 and 605 are repeated in order to find another valid IPv4 address. On the other hand, if the IPv4 address is found to be free, the host adopts the IPv4 address.

The network prefix addresses for the sub-networks do not necessarily remain constant. Network administrators may occasionally change network prefix addresses of the sub-networks, modify/delete existing set of IPv4 addresses, or introduce a new set of IPv4 addresses in the computer network. Further, certain topological changes in the computer network may result in invalidation of IPv4 addresses that were previously valid. Moreover, certain configuration free routing protocols may allow dynamic changes in network prefix addresses of the sub-network routers without any intervention from the network administrator. One such routing protocol is zOSPF, described in a publication draft-dimitri-router-autoconf-00.txt, titled “Autoconfiguration of routers using a link state routing protocol”, by A. Dimitrelis and A. Williams, incorporated herein by reference. zOSPF allows a mesh of routers to configure themselves so that they can forward network traffic without the intervention of a network administrator. The key difference between routers implementing OSPF and zOSPF is that routers running the former are explicitly configured with network prefix addresses for the sub-networks, whereas routers running the latter choose network prefix addresses automatically. In light of the dynamic changes to network prefix addresses, an address allocation mechanism should be such that it can adapt to the changing network configurations. Thus, for an efficient and error free allocation of IPv4 addresses the address allocation mechanism needs to be dynamically updated with the changes in network configuration.

FIG. 7 is a flowchart of the method for dynamically adapting the address allocation mechanism to changing network configurations, in accordance with an embodiment of the current invention. At step 701 routing protocol messages are continuously monitored for any changes in network prefix addresses, corresponding to the various sub-networks. In order to determine the changes, every time the address allocation mechanism receives a routing protocol message from a sub-network, the earlier network prefix addresses associated to the sub-network is compared with those present in the routing protocol message received from the sub-network. This check for change in network prefix addresses is performed at step 703. At step 705, the configuration of the address allocation mechanism is updated once any change in network prefix addresses is noticed while monitoring the routing protocol messages. In order to update the configuration of the address allocation mechanism, the list of IPv4 addresses associated with the sub-network (for which a change was noticed) is updated. The updated list of IPv4 addresses that corresponds to the sub-network has the new network prefix address(es) of the sub-network. The steps 701 to 705 are carried out iteratively in order to dynamically update the address allocation mechanism with the changes in addressing configurations of the computer network system.

In the above method, if change in addressing configuration is detected for a particular sub-network, then the address allocation mechanism may notify about the same to the host machines or router(s) belonging to that sub-network. For example, in case of the DHCP address allocation mechanism, the DHCP server notifies the host (to which IPv4 addresses have been allocated) that the allocated addresses are no longer valid. A DHCP FORCERENEW message is used for this purpose. Once this message has been broadcasted in the sub-network all the current address allocations are revoked. The new IPv4 addresses are then allocated to the hosts in the sub-network in accordance with the method described in FIG. 5.

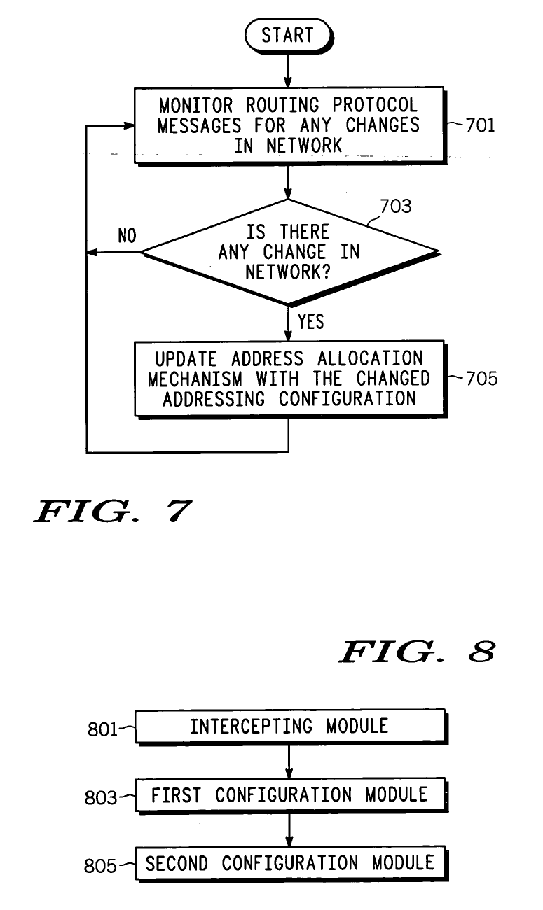

FIG. 8 shows a block diagram of a system for automatic and dynamic configuration of an IPv4 address allocation mechanism, in accordance with one embodiment of the current invention. The system may be incorporated in an existing address allocation mechanism, or it may be implemented on a separate device that is connected to the address allocation mechanism. The system comprises an Intercepting Module 801, a First Configuration Module 803 and a Second Configuration Module 805. Intercepting Module 801 intercepts routing protocol messages exchanged over the computer network. First Configuration Module 803 is coupled to Intercepting Module 801, and it obtains network prefix addresses corresponding to a sub-network in the computer network. Second Configuration Module 805 is coupled to First Configuration Module 803, and it determines valid IPv4 addresses using the network prefix addresses obtained by First Configuration Module 803. In addition to the abovementioned system components, there is a Monitoring Module that is involved in updating the address allocation mechanism with any changes in the addressing configuration of the computer network. The Monitoring Module checks for any changes in network configuration. In case this module notices any changes in network addressing configuration, it updates the address allocation mechanism according to the method described in FIG. 7.

The current invention has many advantages. First it allows automatic and dynamic configuration of IPv4 address allocation mechanisms. The current invention is applicable for both centralized address allocation mechanisms and distributed address allocation mechanisms.

Second, the current invention dynamically adapts the address allocation mechanism with changes in the addressing configuration of the computer network.

Finally, the current invention can be used for a configured routing protocol (like OSPF) or configuration free routing protocols (like zOSPF). In configured routing protocol the network prefix addresses for the sub-networks are chosen by the network administrator. Whereas, in case of configuration free routing protocols, the network prefix addresses for the sub-networks are chosen automatically, without any intervention by the network administrator. Thus, the current invention has the most impact in a computer network that uses configuration free routing protocols. This is because, then the configurations of address allocation of hosts and routers can be fully automatic in the computer network.

It should be apparent to one skilled in the art that though the current invention has been described for IPv4 based networks, the concept of determining valid addresses using the routing protocol messages can also be extended to non IPv4 based networks. Any system that determines network prefix address and/or valid addresses suitable for hosts/routers using routing protocol messages comes under the scope of novelty of the current invention. For example, this invention could be used in an IPv6 network which utilizes DHCPv6.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

1. A method for automatic and dynamic configuration of an address allocation mechanism in a computer network, the computer network comprising one or more sub-networks and at least one router, each sub-network comprising one or more devices, the address allocation mechanism allocating network addresses to the devices, the method comprising:
obtaining routing protocol messages, the routing protocol messages being exchanged in the computer network for routing purposes;
obtaining one or more network prefix addresses that correspond to the sub-networks, the network prefix addresses being obtained using the routing protocol messages; and
determining a range of valid network addresses for the devices using the network prefix addresses.

2. The method as recited in claim 1 wherein the method further comprises automatically allocating the valid network addresses to the devices requesting allocation of the valid network addresses.

3. The method as recited in claim 1 wherein the method further comprises continuously performing monitoring of the routing protocol messages, the monitoring being performed to check if there is a change in addressing configuration of the computer network.

4. The method as recited in claim 3 wherein the method further comprises updating the address allocation mechanism with the changed addressing configuration.

5. The method as recited in claim 1 wherein obtaining the routing protocol messages comprises listening to the routing protocol messages at one or more sub-networks to which the address allocation mechanism is connected.

6. The method as recited in claim 1 wherein obtaining one or more network prefix addresses comprises determining network prefix addresses of one or more sub-networks to which the address allocation mechanism is connected.

7. The method as recited in claim 1 wherein determining the range of valid network addresses comprises identifying valid network addresses from a set of available network addresses at the address allocation mechanism, the valid network addresses having the same network prefix address as the obtained network prefix address corresponding to one of the devices.

8. The method as recited in claim 1 wherein determining range of valid network addresses for the devices comprises:
a. choosing a random number of a suitable length, the suitable length being determined using length of the network prefix address;
b. concatenating the random number with the network prefix address to form a valid network address;
c. checking whether the valid network address is allocated to any other of the devices in the network; and
d. repeating the steps a-b, if the valid network address is allocated to any other of the devices in the network.

9. The method as recited in claim 8 wherein checking of a valid network address is performed using an Address Resolution Protocol (ARP).

10. The method as recited in claim 1 wherein the method automatically and dynamically configures the address allocation mechanisms for the at least one router.

11. A computer program product for use with a computer, the computer program product comprising a computer usable medium having a computer readable program code embodied therein for automatic and dynamic configuration of an address allocation mechanism in a computer network, the computer network comprising one or more sub-networks and at least one router, each sub-network comprising one or more devices, the address allocation mechanism allocating addresses to the devicess, the computer program code performing:
obtaining routing protocol messages, the routing protocol messages being exchanged in the computer network for routing purposes;
obtaining one or more network prefix addresses corresponding to the devices, the network prefix addresses being obtained using the routing protocol messages; and
determining range of valid addresses for the devices using the network prefix addresses.

12. The computer program product as recited in claim 11 wherein the computer program product further comprises a computer program code for automatically allocating the valid network addresses to the devices requesting allocation of the valid network addresses.

13. The computer program product as recited in claim 11 wherein the computer program product further comprises a computer program code for continuously performing monitoring of the routing protocol messages, the monitoring being performed to check if there is a change in addressing configuration of the computer network.

14. The computer program product as recited in claim 13 wherein the computer program product further comprises a computer program code for updating the address allocation mechanism with the changed addressing configuration.

15. The computer program product as recited in claim 11 wherein the computer program code for determining range of valid addresses comprises a computer program code for identifying valid addresses from a set of available IPv4 addresses at the address allocation mechanism, the valid addresses having the same network prefix address as the obtained network prefix address of the devices.

16. The computer program product as recited in claim 11 wherein the computer program code for determining range of valid network addresses comprises a computer program code for:
a. choosing a random number of a suitable length, the suitable length being determined using length of the network prefix address;
b. concatenating the random number with the network prefix address to form a valid network address;
c. checking whether the valid network address is allocated to any other host device in the network; and
d. repeating the steps a-b, if the valid network address is allocated to any other of the devices in the network.

17. A system suitable for automatic and dynamic configuration of an address allocation mechanism in a computer network, the computer network comprising one or more sub-networks and at least one router, each sub-network comprising one or more devices, the address allocation mechanism allocating network addresses to the devices, the system comprising:
a. an intercepting module wherein the intercepting module obtains routing protocol messages, the routing protocol messages being exchanged in the computer network for routing purposes;
b. a first configuration module coupled to the intercepting module wherein the first configuration module obtains one or more network prefix addresses corresponding to specific sub-networks using the routing protocol messages; and
c. a second configuration module coupled to the first configuration module wherein the second configuration module determines range of valid network addresses for the devices using the network prefix addresses.

18. The system as recited in claim 17 wherein the system further comprises a monitoring module wherein the monitoring module updates the address allocation mechanism with any changes in addressing configuration of the computer network.

19. The system as recited in claim 17 wherein the address allocation mechanism is a DHCP server.

20. The system as recited in claim 17 wherein the address allocation mechanism is built into routing protocol in the computer network.

21. The system as recited in claim 17 wherein the address allocation mechanism is built into each of the devices in the computer network.

22. The system as recited in claim 17 wherein the address allocation mechanism allocates IPv4 addresses to routers.
